(19) United States
(12) Patent Application Publication
(10) Pub. No.: US 2025/0062898 A1
(43) Pub. Date: Feb. 20, 2025

(54) TECHNIQUES FOR SECRET SYNCHRONIZATION AND MANAGEMENT ACROSS MULTIPLE CLUSTERS

(71) Applicant: Ally Financial Inc., Detroit, MI (US)

(72) Inventors: Aaron Robinett, Charlotte, NC (US); Shalu Goel, Charlotte, NC (US); Aric Renzo, Huntersville, NC (US); Daniel Foley, Flagstaff, AZ (US); Joel Saju, Charlotte, NC (US); Julian Amrine, Charlotte, NC (US); Muktha Srinivasaiah, Charlotte, NC (US)

(21) Appl. No.: 18/449,277

(22) Filed: Aug. 14, 2023

(51) Int. Cl. H04L 9/08

(52) U.S. Cl. CPC H04L 9/088; H04L 9/0833

(57) ABSTRACT

Methods, systems, and devices to support techniques for secret synchronization and management across multiple clusters are described. An application executed across the set of clusters may manage encryption keys for multiple environments distributed across multiple clusters. For example, the application may detect the creation of an encryption key associated with an environment of the set of clusters. The application may transmit (e.g., push) the encryption key to each cluster of the set of clusters, which may respectively store the encryption key and associate the encryption key with the environment. In some examples, a second application executed on an operations cluster may encrypt a user input using the encryption key.

### FIELD OF TECHNOLOGY

The present disclosure relates generally to distributed systems and data processing, and more specifically to techniques for secret synchronization and management across multiple clusters.

### BACKGROUND

An organization may include multiple teams of developers that develop applications (e.g., computing applications related to financial institutions, user connectivity, user engagement, or the like) that use a containerized architecture. Such as architecture may support a software deployment process that groups code associated with an application with resources, such as files, libraries, or the like, used to execute the application on multiple infrastructures. Using a containerized architecture may improve efficiency and security of application development. In some examples, a developer may incorporate encrypted information into an application using an encryption key associated with environments of the containerized architecture. However, securely managing encryption keys may be challenging.

### SUMMARY

The described techniques relate to improved methods, systems, devices, and apparatuses that support techniques for secret synchronization and management across multiple clusters. Generally, the described techniques provide for managing encryption keys for multiple environments distributed across multiple clusters. For example, an application may detect the creation of an encryption key associated with an environment of a set of clusters. The application may transmit (e.g., push) the encryption key to each cluster of the set of clusters, which may respectively store the encryption key and associate the encryption key with the environment. In some examples, a second application executed on an operations cluster may encrypt a user input using the encryption key.

A method by an apparatus is described. The method may include detecting, by a first application executed on a plurality of clusters associated with a first environment, a generation of an encryption key on a primary cluster of the plurality of clusters, transmitting the encryption key to each cluster of the plurality of clusters in response to detecting the generation of the encryption key on the primary cluster, and encrypting, by a second application executed on an operations cluster of the plurality of clusters, a user input based at least in part on the encryption key and the first environment.

An apparatus is described. The apparatus may include one or more memories storing processor executable code, and one or more processors coupled with the one or more memories. The one or more processors may individually or collectively operable to execute the code to cause the apparatus to detect, by a first application executed on a plurality of clusters associated with a first environment, a generation of an encryption key on a primary cluster of the plurality of clusters, transmit the encryption key to each cluster of the plurality of clusters in response to detecting the generation of the encryption key on the primary cluster, and encrypting, by a second application execute on an operations cluster of the plurality of clusters, a user input based at least in part on the encryption key and the first environment.

Another apparatus is described. The apparatus may include means for detecting, by a first application executed on a plurality of clusters associated with a first environment, a generation of an encryption key on a primary cluster of the plurality of clusters, means for transmitting the encryption key to each cluster of the plurality of clusters in response to detecting the generation of the encryption key on the primary cluster, and means for encrypting, by a second application executed on an operations cluster of the plurality of clusters, a user input based at least in part on the encryption key and the first environment.

A non-transitory computer-readable medium storing code is described. The code may include instructions executable by a processor to detect, by a first application executed on a plurality of clusters associated with a first environment, a generation of an encryption key on a primary cluster of the plurality of clusters, transmit the encryption key to each cluster of the plurality of clusters in response to detecting the generation of the encryption key on the primary cluster, and encrypting, by a second application execute on an operations cluster of the plurality of clusters, a user input based at least in part on the encryption key and the first environment.

In some examples of the method, apparatus, and non-transitory computer-readable medium described herein, identifying, based at least in part on a second user input, the first environment from a plurality of environments, wherein encrypting the user input may be based at least in part on identifying the first environment.

Some examples of the method, apparatus, and non-transitory computer-readable medium described herein may further include operations, features, means, or instructions for receiving, from a device associated with the operations cluster, the second user input based at least in part on transmitting an indication of the plurality of environments to the device.

Some examples of the method, apparatus, and non-transitory computer-readable medium described herein may further include operations, features, means, or instructions for determining that the encryption key may be associated with the first environment based at least in part on identifying the first environment and retrieving the encryption key based at least in part on the determining, wherein encrypting the user input may be further based at least in part on retrieving the encryption key.

Some examples of the method, apparatus, and non-transitory computer-readable medium described herein may further include operations, features, means, or instructions for receiving, from a device associated with the operations cluster, the user input, wherein encrypting the user input may be further based at least in part on receiving the user input and providing the encrypted user input to the device.

Some examples of the method, apparatus, and non-transitory computer-readable medium described herein may further include operations, features, means, or instructions for executing a third application on a cluster of the plurality of clusters using the encrypted user input, wherein the encrypted user input comprises a key-value pair associated with the third application.

Some examples of the method, apparatus, and non-transitory computer-readable medium described herein may further include operations, features, means, or instructions for detecting, by the first application, a generation of one or more authentication credentials for a namespace, wherein the generation may be detected on at least one cluster of the plurality of clusters, generating, by the first application, one or more access credentials based at least in part on the one or more authentication credentials, and transmitting the one or more access credentials to the operations cluster based at least in part on generating the one or more access credentials.

Some examples of the method, apparatus, and non-transitory computer-readable medium described herein may further include operations, features, means, or instructions for detecting, by a third application executed on a plurality of second clusters associated with a second environment, a generation of a second encryption key on a primary second cluster of the plurality of second clusters, transmitting the second encryption key to each second cluster of the plurality of second clusters in response to detecting the generation of the second encryption key on the primary second cluster, and encrypting, by the second application executed on the operations cluster, a second user input based at least in part on the second encryption key and the second environment.

A method by an apparatus is described. The method may include detecting, by a first application executed on a plurality of clusters associated with a first environment, a generation of an encryption key on a primary cluster of the plurality of clusters, transmitting the encryption key to each cluster of the plurality of clusters in response to detecting the generation of the encryption key on the primary cluster, and encrypting, by a second application execute on an operations cluster of the plurality of clusters, a user input based at least in part on the encryption key and the first environment.

An apparatus is described. The apparatus may include one or more memories storing processor executable code, and one or more processors coupled with the one or more memories. The one or more processors may individually or collectively operable to execute the code to cause the apparatus to detect, by a first application executed on a plurality of clusters associated with a first environment, a generation of an encryption key on a primary cluster of the plurality of clusters, transmit the encryption key to each cluster of the plurality of clusters in response to detecting the generation of the encryption key on the primary cluster, and encrypting, by a second application execute on an operations cluster of the plurality of clusters, a user input based at least in part on the encryption key and the first environment.

Another apparatus is described. The apparatus may include means for detecting, by a first application executed on a plurality of clusters associated with a first environment, a generation of an encryption key on a primary cluster of the plurality of clusters, means for transmitting the encryption key to each cluster of the plurality of clusters in response to detecting the generation of the encryption key on the primary cluster, and means for encrypting, by a second application execute on an operations cluster of the plurality of clusters, a user input based at least in part on the encryption key and the first environment.

A non-transitory computer-readable medium storing code is described. The code may include instructions executable by a processor to detect, by a first application executed on a plurality of clusters associated with a first environment, a generation of an encryption key on a primary cluster of the plurality of clusters, transmit the encryption key to each cluster of the plurality of clusters in response to detecting the generation of the encryption key on the primary cluster, and encrypting, by a second application execute on an operations cluster of the plurality of clusters, a user input based at least in part on the encryption key and the first environment.

In some examples of the method, apparatus, and non-transitory computer-readable medium described herein, identifying, based at least in part on a second user input, the first environment from a plurality of environments, wherein encrypting the user input may be based at least in part on identifying the first environment.

Some examples of the method, apparatus, and non-transitory computer-readable medium described herein may further include operations, features, means, or instructions for receiving, from a device associated with the operations cluster, the second user input based at least in part on transmitting an indication of the plurality of environments to the device.

Some examples of the method, apparatus, and non-transitory computer-readable medium described herein may further include operations, features, means, or instructions for determining that the encryption key may be associated with the first environment based at least in part on identifying the first environment and retrieve the encryption key based at least in part on the encryption key being associated with the first environment, wherein encrypting the user input may be further based at least in part on retrieving the encryption key.

Some examples of the method, apparatus, and non-transitory computer-readable medium described herein may further include operations, features, means, or instructions for receiving, from a device associated with the operations cluster, the user input, wherein encrypting the user input may be further based at least in part on receiving the user input and provide the encrypted user input to the device.

Some examples of the method, apparatus, and non-transitory computer-readable medium described herein may further include operations, features, means, or instructions for executing a third application on a cluster of the plurality of clusters using the encrypted user input, wherein the encrypted user input comprises a key-value pair associated with the third application.

Some examples of the method, apparatus, and non-transitory computer-readable medium described herein may further include operations, features, means, or instructions for detecting, by the first application, a generation of one or more authentication credentials for a namespace, wherein the generation may be detected on at least one cluster of the plurality of clusters, generate, by the first application, one or more access credentials based at least in part on the one or more authentication credentials, and transmit the one or more access credentials to the operations cluster based at least in part on generating the one or more access credentials.

Some examples of the method, apparatus, and non-transitory computer-readable medium described herein may further include operations, features, means, or instructions for detecting, by a third application executed on a plurality of second clusters associated with a second environment, a generation of a second encryption key on a primary second cluster of the plurality of second clusters, transmit the second encryption key to each second cluster of the plurality of second clusters in response to detecting the generation of the second encryption key on the primary second cluster, and encrypting, by the second application execute on the operations cluster, a second user input based at least in part on the second encryption key and the second environment.

### BRIEF DESCRIPTION OF THE DRAWINGS

FIG. 1 shows an example of a system that supports techniques for secret synchronization and management across multiple clusters in accordance with aspects of the present disclosure.

FIG. 2 shows an example of a system that supports techniques for secret synchronization and management across multiple clusters in accordance with aspects of the present disclosure.

FIG. 3 shows an example of a system that supports techniques for secret synchronization and management across multiple clusters in accordance with aspects of the present disclosure.

FIG. 4 shows an example of a system that supports techniques for secret synchronization and management across multiple clusters in accordance with aspects of the present disclosure.

FIG. 5 shows a diagram of a system including a device that supports techniques for secret synchronization and management across multiple clusters in accordance with aspects of the present disclosure.

FIG. 6 shows a flowchart illustrating methods that support techniques for secret synchronization and management across multiple clusters in accordance with aspects of the present disclosure.

### DETAILED DESCRIPTION

In some cases, an organization (e.g., a company, a corporation, a financial institution, or the like) may employ a containerized computing architecture to support development and deployment of applications. For example, the containerized architecture may include a set of computing clusters, with each cluster including one or more nodes that may execute applications within containers. To support application development, the containerized architecture may include multiple namespaces. A namespace may be employed by a user or a group of users to develop or deploy (or both) applications within containers executed in the set of clusters. In some examples, namespaces may be organized in accordance with one or more environments across the containerized architecture.

As part of application development and deployment, a user may encrypt information, such as key-value pairs or other confidential information, using an encryption key of a key pair for a particular environment. However, managing encryption keys for multiple namespaces across multiple clusters may increase security risks, reduce efficiency of application development, or both. For example, encryption keys managed by individual users involved with application development and management may increase the likelihood of human-error in managing the encryption keys, and may expose the encryption keys to malicious actors, thus posing a security threat. For instance, manual secret creation may be insecure, time consuming, and prone to user-based errors. Similarly, users may re-encrypt the same secret multiple times for deployment to different clusters in the same environment, resulting in overhead and inefficiencies in secret management. In some cases, continuous integration (CI)/continuous deployment (CD) pipeline authentication tokens for multiple regions may be synchronized and/or updated each time additional projects are created, and existing secret management techniques, such as for encryption keys across multiple clusters of a containerized architecture, may be desirable.

As described herein, an application executed across the set of clusters may automatically manage encryption keys for multiple environments distributed across multiple clusters. For example, the application may detect the creation of an encryption key associated with an environment of the set of clusters. The application may transmit (e.g., push) the encryption key to each cluster of the set of clusters, which may respectively store the encryption key and associate the encryption key with the environment. In some examples, a second application executed on an operations cluster may encrypt a user input using the encryption key. Using the applications to manage encryption keys may improve security of the system, for example, by mitigating human interaction with the encryption keys, thereby reducing likelihood of user error, opportunity for malicious attacks, or both. Additionally, using the applications may increase the speed and accuracy of distributing encryption keys to multiple clusters, which may decrease costs associated with the system and improve user experience. For example, the described techniques may enable automation of secret management across multiple clusters, thereby saving on costs and improving efficiency. Such techniques may enhance security by limiting access to encrypted information, and developers may thus push encrypted keys into repositories without knowing or having access to the contents of the encrypted keys. Further, aspects of the present disclosure may enable rapid re-generation and distribution of additional encryption keys and authentication tokens in scenarios where keys are compromised (e.g., and need to be disabled).

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally or alternatively solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

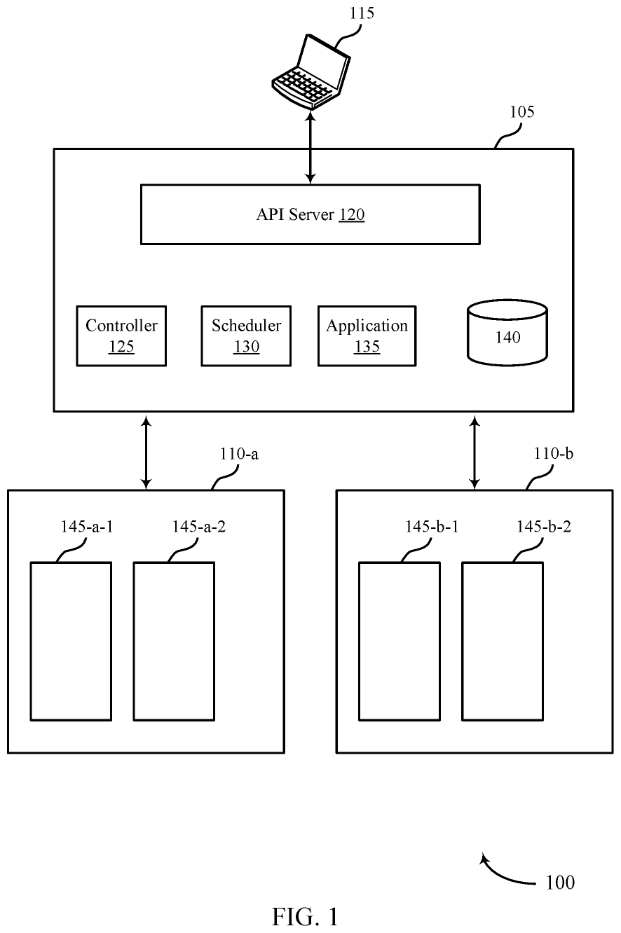

FIG. 1 shows an example of a system 100 that supports techniques for secret synchronization and management across multiple clusters in accordance with aspects of the present disclosure. The system 100 may illustrate a containerized architecture and may be an example of a cluster (e.g., a computing cluster) configured to execute one or more containers 145 across one or more nodes. The system 100 may be executed across one or more computing systems, including one or more physical computing machines (e.g., on-premises computers), one or more cloud-based environments, one or more virtual machine environments, or a combination thereof. The one or more computing systems may employ various operating systems and may support execution of the containers 145 within each of the various operating systems.

The system 100 may include a node 105, which may orchestrate and manage operations across the system 100. For example, the node 105 may manage the state of the cluster, and may assign tasks, such as executing containers 145, to one or more nodes 110. A node 110 may be an example of a worker node and may provide computing resources for executing applications within one or more containers 145. For example, the node 110-a may include resources for executing applications within the container 145-a-1 and the container 145-a-2, and the node 110-b may include resources for executing applications within the container 145-b-1 and the container 145-b-2.

In some cases, the node 105 may include a controller 125 and a scheduler 130, which may support in scheduling resources and assigning tasks across the system 100. Additionally, resources of the system 100 (e.g., computing resources, storage resources, communications resources) may be organized into one or more namespaces of the system 100. For example, multiple users or groups of users may interact with the system 100 using respective namespaces, which may support different groups of users in building and deploying applications using the system 100.

A namespace may refer to a set of signs (e.g., a set of names) used for identifying and referring to respective objects, where each object may have a unique name that is used for identification. In some examples, namespaces within the system 100 may include or may be associated with one or more encryption keys. An encryption key may be used to encrypt information, such as one or more key-value pairs, and may support secure communication of the information. In some cases, an encryption key as described herein may be an example of a public key of a key pair (e.g., an asymmetric key pair). In such cases, a private key of the key pair may be used to decrypt information encrypted using the public encryption key. Additionally, or alternatively, an encryption key as described herein may be an example a symmetric key of a key pair, and a separate copy of the encryption key may be used to decrypt information. A node 105 may include or may interface with an encryption controller, which may generate an encryption key pair. In some cases, the encryption controller may securely provide encryption keys of the key pair (e.g., a public key, a private key, or both) to the node 105.

The system 100 may store one or more encryption keys for the namespaces associated with the system 100 within a database 140, such as a distributed key-value database. The database 140 may provide reliable and secure data stored for the system 100, and may store configuration data, status, metadata, credential information, or combination thereof for the system 100, among other examples. Additionally, the node 105 may include an application programming interface (API) server 120, which may support communications with a device 115 using an API. For example, the API server 120 may receive commands or messages from the device 115 (e.g., via an API call) and may transmit communications to the device 115 (e.g., as a response to the API call).

In some cases, an application 135 executed across a set of clusters may manage encryption keys for multiple environments distributed across multiple clusters. For example, the application 135 may detect the creation of an encryption key associated with an environment of the set of clusters. The application 135 may transmit (e.g., push) the encryption key to each cluster of the set of clusters, which may respectively store the encryption key and associate the encryption key with the environment. In some implementations, the application 135 may push service account tokens (e.g., at creation time) from application namespaces to a separate management region. In such cases, one or more automated processes may consume to enable developer CI/CD automation, for example, enable rapid deployment of applications to clusters. The application 135 may synchronize keys (e.g., sealing keys) across different regions that application teams may deploy to, enabling users of a second application to encrypt sensitive data at an environment level (e.g., pre-production, production) rather than at an individual cluster level. The second application may be executed on an operations cluster and may be used to encrypt one or more user inputs using the encryption key. For example, the second application may provide end users with an interactive front end for encrypting one or more key/value pairs consumed by an application. In such cases, developers safely store the encoded string the application returns, which may be integrated with existing CI/CD processes.

Using the application 135 to manage encryption keys may improve security of the system, for example by mitigating human interaction with the encryption keys, which may otherwise introduce an increased likelihood of user error, provide opportunities for malicious attacks, or among other issues. Additionally, using the application 135 may increase the speed and accuracy of distributing encryption keys to multiple clusters, which may decrease costs associated with the system and improve user experience.

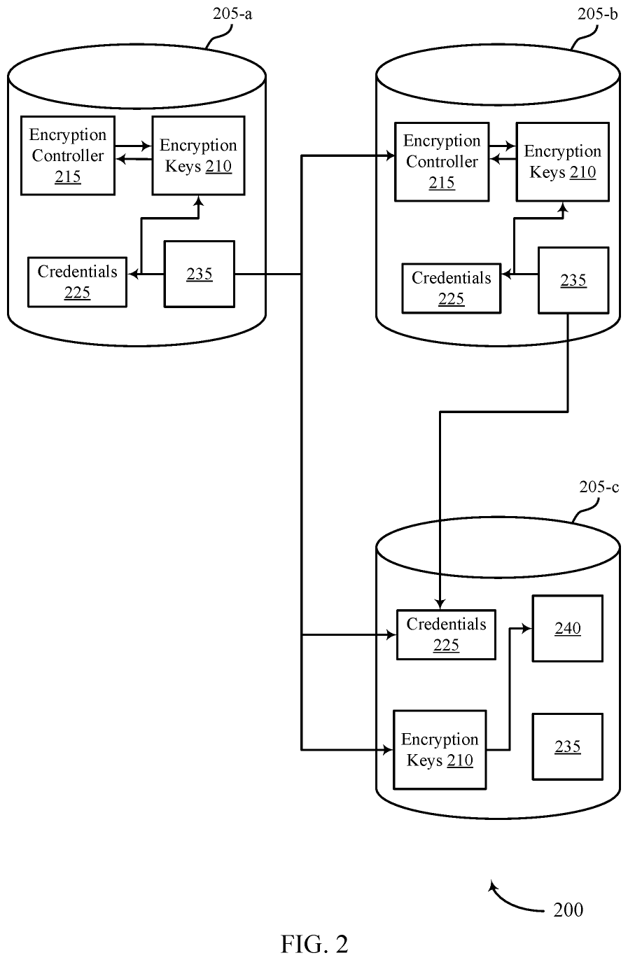

FIG. 2 shows an example of a system 200 that supports techniques for secret synchronization and management across multiple clusters in accordance with aspects of the present disclosure. The system 200 may include multiple clusters 205, which may each be an example of or include aspects of the cluster included in the system 100 as described with reference to FIG. 1. For example, the system 200 may include a cluster 205-a and a cluster 205-b, which may each implement an application 235. The application 235 may be an example of the application 135 of the system 100 described with reference to FIG. 1.

The system 200 may employ multiple namespaces, which may each be associated with a single cluster 205 or may be common to multiple clusters 205. A namespace may be employed by a user or a group of users to develop or deploy (or both) applications within containers executed in the set of clusters 205. In some examples, namespaces may be organized in accordance with one or more environments across the clusters 205. As part of application development and deployment, a user may encrypt information, such as key-value pairs or other confidential information, using an encryption key 210 of a key pair for a particular environment.

For example, the system 200 may include or may make use of an encryption controller 215, which may securely generate one or more encryption keys 210 for the environment. In some examples, the cluster 205-a may execute the encryption controller 215, and the encryption controller 215 may store the generated encryption keys on a database associated with the cluster 205-a. However, in some cases, the encryption controller 215 may not provide the encryption keys 210 to other clusters 205, such as the cluster 205-b, the operation cluster 205-c, or both.

To manage encryption keys 210 across multiple clusters 205, the system 200 may include an application 235. The application 235 may monitor the encryption controller 215, the encryption keys 210, or both within, by way of example, the cluster 205-a. For example, the cluster 205-a may support event monitoring for the application 235, and the application 235 may therefore monitor for events related to the encryption keys 210, such as a creation of an encryption key 210, an update or modification of an encryption key 210, a deletion of an encryption key 210, or a combination thereof. In some aspects, the application 235 may provide multiple functionalities, such as polling keys and watching deployment zones (e.g., clusters) for newly created tokens. As an example, the application 235 may poll on the keys (e.g., scaling keys) on a primary deployment zone (e.g., a primary cluster) and may replicate the key to one or more other zones (e.g., a secondary cluster, a tertiary cluster) within a deployment region or environment (e.g., production, quality assurance (QA), staging, development, or the like). In such cases, the replication of the key may ensure that a particular key (e.g., a secret key) is decrypted on other zones (e.g., primary and secondary clusters). Further, the application 235 may watch (e.g., monitor) each of the deployment zones for newly created authentication tokens, and the application 235 may push them to a particular cluster (e.g., an operational/administrative cluster). In such cases, the store authentication tokens may be stored in a format consumed by CI/CD tools and pipelines.

In response to detecting an event associated with the encryption key 210, the application 235 may interface with the other clusters 205 of the system 200 (e.g., the cluster 205-b, the cluster 205-c), for example using one or more API calls, to synchronize the encryption keys 210 across the clusters 205. For example, the application 235 may transmit an encryption key 210 generated by the encryption controller 215 to each cluster 205 of the system 200. A cluster 205, in response to receiving the encryption key 210, may securely store the encryption key 210 (e.g., in a database 140) and may associate the encryption key 210 with the environment associated with the encryption controller 215.

In some cases, each environment associated with the clusters 205 of the system 200 may execute the application 235, or a copy of the application 235, to manage encryption keys 210 across each environment of the system 200. For example, if an encryption controller 215 executed on the cluster 205-a and associated with a second environment generates an encryption key 210, an application 235 executed on the cluster 205-a and associated with the second environment may detect the generation of the second encryption key 210. In response, the application 235 may transmit the second encryption key 210 to each cluster 205 of the system 200. A cluster 205, in response to receiving the second encryption key 210, may securely store the second encryption key 210 (e.g., in a database 140) and may associate the second encryption key 210 with the second environment associated with the encryption controller 215.

Additionally, or alternatively, an application 235 may manage and coordinate one or more authentication credentials 225 associated with one or more namespaces of the system 200. In some cases, as part of application development and deployment, the system 200 may include or may make use of one or more development pipeline tools to automate various stages of application development, such as building, testing, and deploying applications. A user or group of users of a namespace of the system 200 may access or interface with the one or more development pipeline tools using the one or more authentication credentials 225 (e.g., as access tokens).

In some cases, the application 235 may monitor for events related to the authentication credentials 225, such as a creation of an authentication credential 225, an update or modification of an authentication credential 225, a deletion of an authentication credential 225, or a combination thereof. For example, as part of provisioning a namespace, the system 200 may generate one or more authentication credentials 225 associated with the namespace. In response to detecting the generation of the one or more authentication credentials 225, the application 235 may transmit the one or more authentication credentials 225 to each cluster 205 of the system 200. A cluster 205, in response to receiving the one or more authentication credentials 225, may securely store the one or more authentication credentials 225 (e.g., in a database 140) and may associate the one or more authentication credentials 225 with the provisioned namespace.

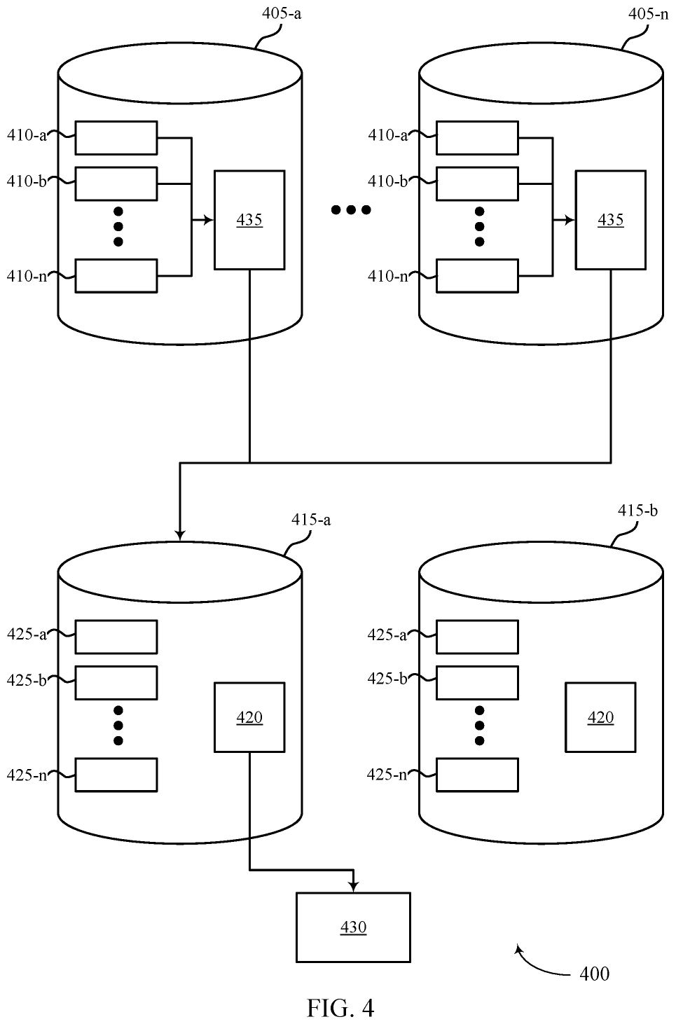

In some examples, an operation cluster 205 (e.g., the operation cluster 205-c) may execute an application 240 to securely encrypt information for users of the system 200. For example, the application 240 may use encryption keys 210 received from other clusters 205 (e.g., the cluster 205-a, the cluster 205-b) to encrypt user input, such as a key-value pair, and may provide the encrypted user input to the user, as described in greater detail with reference to FIG. 4.

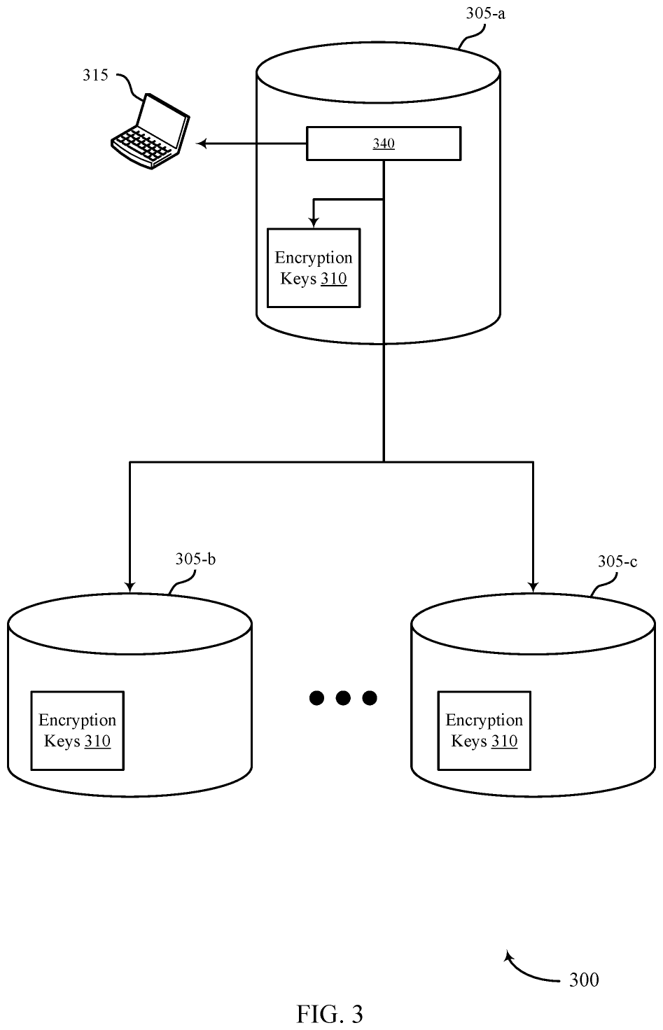

FIG. 3 shows an example of a system 300 that supports techniques for secret synchronization and management across multiple clusters in accordance with aspects of the present disclosure. The system 300 may include multiple clusters 305, which may each be an example of or include aspects of the cluster included in the system 100, the system 200, or both as described with reference to FIGS. 1 and 2. For example, the system 300 may include a cluster 305-a (e.g., an operations cluster) that may implement an application 340, which may be an example of the application 240 of the system 200.

The system 300 may support secure encryption of information for users of the system 300. For example, a user of the system 300 may employ a device 315, such as a smartphone, a tablet, a laptop, or the like, to interface with the cluster 305-a and encrypt information, such as a key-value pair, for a selected environment (e.g., an environment selected form multiple environments, such as development, QA, production, or the like) of the system 300. For example, the device 315 may be in communication with the cluster 305-a using one or more communication channels, such as via an online portal, a website or application (e.g., a client-server application), or both. In some cases, the application 340 may include a front-end user interface which may allow the device 315 to receive prompts from and provide input to the application 340.

By way of example, the application 340 may provide the device 315 with an indication of the set of environments associated with the system 300, such as a selection (e.g., a menu, a list) of the set of environments. Additionally, the application 340 may provide the device 315 with an indication of a target cluster for the encrypted information. A user may, using the device 315, select an environment, and the device 315 may transmit the selected environment to the application 340. Further, the application 340 may provide a prompt to the device 315 for the information to be encrypted, along with metadata for the encrypted information, such as a name or identifier. A user may input the information to be encrypted and associated metadata, and the device 315 may transmit the user inputs to the application 340.

In response, the application 340 may identify the selected environment and may determine (e.g., pull) an encryption key 310 for the selected environment. The application 340 may retrieve the identified encryption key 310 (e.g., from a database 140), and may use the encryption key 310 to encrypt the information received form the device 315. In some examples, the application 340 may provide the encrypted information to the user. For example, the application 340 may transmit the encrypted information to the device 315, and the device 315 may provide the encrypted information (e.g., as a downloadable file, by displaying the encrypted information). In some examples, the application 340 may not retain the encrypted information, may not retain the encryption key 310, or both. For example, the application 340 may temporarily store the encryption key 310 and encrypted information within a volatile memory and may remove the encryption key 310 and encrypted information from the volatile memory after providing the encrypted information to the user.

In some cases, the user may incorporate the encrypted information into one or more application executed across the system 300. For example, an application that includes the encrypted information and is executed on a non-operations cluster 305, such as the cluster 305-b, the cluster 305-c, or both, may decrypt the encrypted information using the encryption keys 310 of the non-operations cluster 305. Using the application 340 to encrypt information for the development and deployment of applications may increase security and efficiency of application development. For example, the application 340 may provide a central location for users of the system 300 to encrypt information for multiple environments (e.g., development, QA, production, or the like) and clusters 305 of the system 300, without exposing encryption keys 310 to the users.

FIG. 4 shows an example of a system 400 that supports techniques for secret synchronization and management across multiple clusters in accordance with aspects of the present disclosure. The system 400 may include multiple clusters 405, which may each be an example of or include aspects of the clusters 205, the cluster 305, or both as described with reference to FIGS. 1, 2, and 3. For example, the system 400 may include cluster 405-a through cluster 405-n, which may each implement an application 435, which may be an example of the application 135, the application 235, or both. Additionally, the system 400 may include one or more operations cluster 415, such as the operations cluster 415-a and the operations cluster 415-b.

The system 400 may include multiple namespaces 410, which may each be associated with a single cluster 405 or may be common to multiple clusters 405. For example, the system 400 may include a namespace 410-a, a namespace 410-b, through to a namespace 410-n. A namespace 410 may be employed by a user or a group of users to develop or deploy (or both) applications within containers executed in the set of clusters 405. The application 435 may manage and coordinate one or more authentication credentials 425 associated with the one or more namespaces 410 of the system 400. For example, the application 435 may manage authentication credentials 425-a that correspond to the namespace 410-a, may manage authentication credentials 425-b that correspond to the namespace 410-b, and so on, to authentication credentials 425-n that correspond to the namespace 410-n.

In some cases, as part of application development and deployment, the system 200 may include or may make use of one or more development pipeline tools to automate various stages of application development, such as building, testing, and deploying applications. A user or group of users of a namespace 410 of the system 400 may access or interface with the one or more development pipeline tools using the one or more authentication credentials 425 (e.g., as access tokens) corresponding to the namespace 410.

The application 435 may monitor for events related to the authentication credentials 425, such as a creation of an authentication credential 425, an update or modification of an authentication credential 425, a deletion of an authentication credential 425, or a combination thereof. For example, as part of provisioning a namespace 410, the system 400 may generate one or more authentication credentials 425 associated with the namespace 410. In response to detecting the generation of the one or more authentication credentials 425, the application 435 may transmit the one or more authentication credentials 425 to each cluster 405 of the system 400, as well as each operations cluster 415 of the system 400. A cluster 405, a cluster 415, or both may, in response to receiving the one or more authentication credentials 425, securely store the one or more authentication credentials 425 (e.g., in a database 140) and may associate the one or more authentication credentials 425 with the provisioned namespace 410.

In some examples, an operations cluster 415 (e.g., the operations cluster 415-a) may replicate the one or more authorization credentials 425 to additional operations cluster 415 (e.g., the operations cluster 415-b). Additionally, or alternatively, an operations cluster 415 may store the one or more authorization credentials 425 in a format supported by the one or more development pipeline tools. Further, a namespace 420 of an operations cluster 415 may provide authentication credentials 425 to a credential manager 430 (e.g., a namespace may act as a source of credentials that may be retrieved by another aspect of the system), which may be an example of a cloud-based management application for authentication credentials 425.

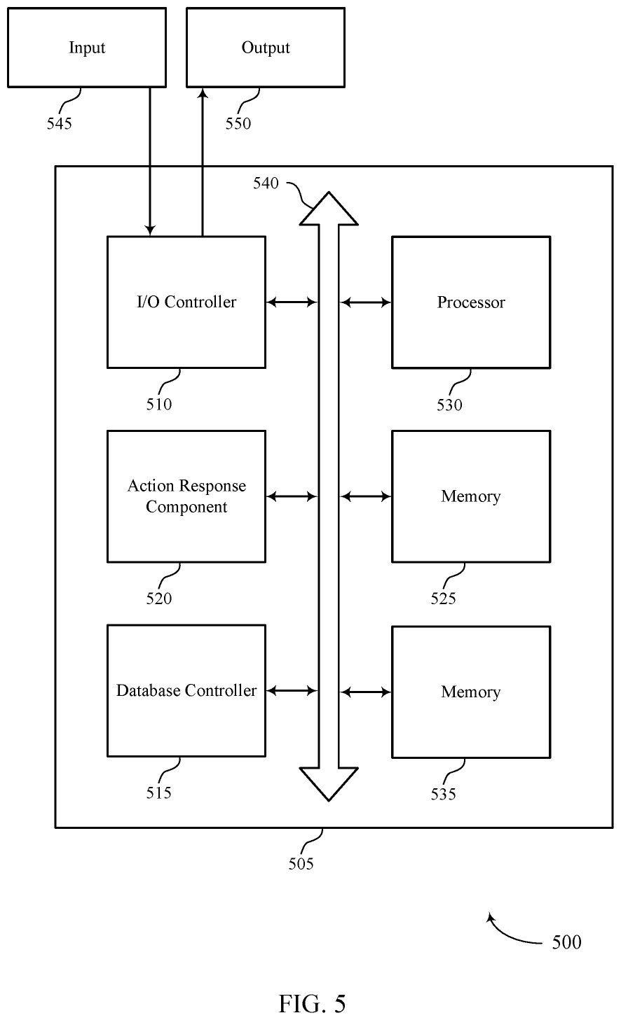

FIG. 5 shows a diagram of a system 500 including a device 505 that supports techniques for secret synchronization and management across multiple clusters in accordance with aspects of the present disclosure. The device 505 may include components for bi-directional voice and data communications including components for transmitting and receiving communications, such as an action response component 520, an I/O controller 510, a database controller 515, at least one memory 525, at least one processor 530, and a database 535. These components may be in electronic communication or otherwise coupled (e.g., operatively, communicatively, functionally, electronically, electrically) via one or more buses (e.g., a bus 540).

The I/O controller 510 may manage input signals 545 and output signals 550 for the device 505. The I/O controller 510 may also manage peripherals not integrated into the device 505. In some cases, the I/O controller 510 may represent a physical connection or port to an external peripheral. In some cases, the I/O controller 510 may utilize an operating system such as iOS®, ANDROID®, MS-DOS®, MS-WINDOWS®, OS/2®, UNIX®, LINUX®, or another known operating system. Additionally, or alternatively, the I/O controller 510 may represent or interact with a modem, a keyboard, a mouse, a touchscreen, or a similar device. In some cases, the I/O controller 510 may be implemented as part of a processor. In some examples, a user may interact with the device 505 via the I/O controller 510 or via hardware components controlled by the I/O controller 510.

The database controller 515 may manage data storage and processing in a database 535. The database 535 may be external to the device 505, temporarily or permanently connected to the device 505, or a data storage component of the device 505. In some aspects, the database controller 515 may be used to call an API for container management (e.g., for automation, scaling, and/or management of containerized applications). In some cases, a user may interact with the database controller 515. In some other cases, the database controller 515 may operate automatically without user interaction. The database 535 may be an example of a persistent data store, a single database, a distributed database, multiple distributed databases, a database management system, or an emergency backup database.

Memory 525 may include random-access memory (RAM) and read-only memory (ROM). The memory 525 may store computer-readable, computer-executable software including instructions that, when executed, cause the processor to perform various functions described herein. In some cases, the memory 525 may contain, among other things, a basic input/output system (BIOS) that may control basic hardware or software operation such as the interaction with peripheral components or devices.

The processor 530 may include an intelligent hardware device (e.g., a general-purpose processor, a digital signal processor (DSP), a central processing unit (CPU), a microcontroller, an application-specific integrated circuit (ASIC), a field programmable gate array (FPGA), a programmable logic device, a discrete gate or transistor logic component, a discrete hardware component, or any combination thereof). In some cases, the processor 530 may be configured to operate a memory array using a memory controller. In some other cases, a memory controller may be integrated into the processor 530. The processor 530 may be configured to execute computer-readable instructions stored in memory 525 to perform various functions (e.g., functions or tasks supporting techniques for secret synchronization and management across multiple clusters).

For example, the action response component 520 may be configured as or otherwise support a means for detecting, by a first application executed on a plurality of clusters associated with a first environment, a generation of an encryption key on a primary cluster of the plurality of clusters. The action response component 520 may be configured as or otherwise support a means for transmitting the encryption key to each cluster of the plurality of clusters in response to detecting the generation of the encryption key on the primary cluster. The action response component 520 may be configured as or otherwise support a means for encrypting, by a second application executing on an operations cluster of the plurality of clusters, a user input based at least in part on the encryption key and the first environment.

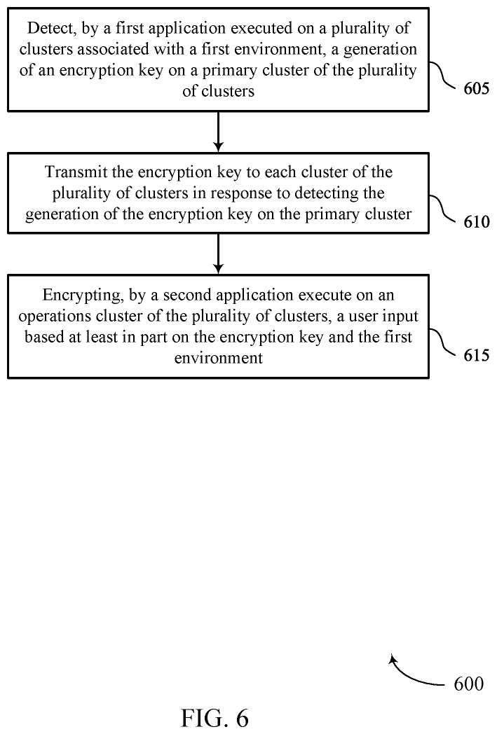

FIG. 6 shows a flowchart illustrating a method 600 that supports techniques for secret synchronization and management across multiple clusters in accordance with aspects of the present disclosure. The operations of the method 600 may be implemented by an encryption key operator or its components as described herein. For example, the operations of the method 600 may be performed by an application as described with reference to FIGS. 1 through 5. In some examples, an encryption key operator may execute a set of instructions to control the functional elements of the encryption key operator to perform the described functions. Additionally, or alternatively, the encryption key operator may perform aspects of the described functions using special-purpose hardware.

At 605, the method may include detecting, by a first application executed on a plurality of clusters associated with a first environment, a generation of an encryption key on a primary cluster of the plurality of clusters. The operations of 605 may be performed in accordance with examples as disclosed herein.

At 610, the method may include transmitting the encryption key to each cluster of the plurality of clusters in response to detecting the generation of the encryption key on the primary cluster. The operations of 610 may be performed in accordance with examples as disclosed herein.

At 615, the method may include encrypting, by a second application executed on an operations cluster of the plurality of clusters, a user input based at least in part on the encryption key and the first environment. The operations of 615 may be performed in accordance with examples as disclosed herein.

In some examples, an apparatus as described herein may perform a method or methods, such as the method 600. The apparatus may include features, circuitry, logic, means, or instructions (e.g., a non-transitory computer-readable medium storing instructions executable by a processor) for detecting, by a first application executed on a plurality of clusters associated with a first environment, a generation of an encryption key on a primary cluster of the plurality of clusters, transmitting the encryption key to each cluster of the plurality of clusters in response to detecting the generation of the encryption key on the primary cluster, and encrypting, by a second application executed on an operations cluster of the plurality of clusters, a user input based at least in part on the encryption key and the first environment.

In some examples of the method 600 and the apparatus described herein, identifying, based at least in part on a second user input, the first environment from a plurality of environments, wherein encrypting the user input may be based at least in part on identifying the first environment.

In some examples of the method 600 and the apparatus described herein, identifying the first environment may include operations, features, circuitry, logic, means, or instructions for receiving, from a device associated with the operations cluster, the second user input based at least in part on transmitting an indication of the plurality of environments to the device.

Some examples of the method 600 and the apparatus described herein may further include operations, features, means, or instructions for determining that the encryption key may be associated with the first environment based at least in part on identifying the first environment and retrieving the encryption key based at least in part on the determining, wherein encrypting the user input may be further based at least in part on retrieving the encryption key.

Some examples of the method 600 and the apparatus described herein may further include operations, features, means, or instructions for receiving, from a device associated with the operations cluster, the user input, wherein encrypting the user input may be further based at least in part on receiving the user input and providing the encrypted user input to the device.

Some examples of the method 600 and the apparatus described herein may further include operations, features, means, or instructions for executing a third application on a cluster of the plurality of clusters using the encrypted user input, wherein the encrypted user input comprises a key-value pair associated with the third application.

Some examples of the method 600 and the apparatus described herein may further include operations, features, means, or instructions for detecting, by the first application, a generation of one or more authentication credentials for a namespace, wherein the generation may be detected on at least one cluster of the plurality of clusters, generating, by the first application, one or more access credentials based at least in part on the one or more authentication credentials, and transmitting the one or more access credentials to the operations cluster based at least in part on generating the one or more access credentials.

Some examples of the method 600 and the apparatus described herein may further include operations, features, means, or instructions for detecting, by a third application executed on a plurality of second clusters associated with a second environment, a generation of a second encryption key on a primary second cluster of the plurality of second clusters, transmitting the second encryption key to each second cluster of the plurality of second clusters in response to detecting the generation of the second encryption key on the primary second cluster, and encrypting, by the second application executed on the operations cluster, a second user input based at least in part on the second encryption key and the second environment.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
detecting, by a first application executed on a plurality of clusters associated with a first environment, a generation of an encryption key on a primary cluster of the plurality of clusters;
transmitting the encryption key to each cluster of the plurality of clusters in response to detecting the generation of the encryption key on the primary cluster; and
encrypting, by a second application executed on an operations cluster of the plurality of clusters, a user input based at least in part on the encryption key and the first environment.

2. The method of claim 1, further comprising:
identifying, based at least in part on a second user input, the first environment from a plurality of environments, wherein encrypting the user input is based at least in part on identifying the first environment.

3. The method of claim 2, further comprising:
receiving, from a device associated with the operations cluster, the second user input based at least in part on transmitting an indication of the plurality of environments to the device.

4. The method of claim 2, further comprising:
determining that the encryption key is associated with the first environment based at least in part on identifying the first environment; and
retrieving the encryption key based at least in part on the determining, wherein encrypting the user input is further based at least in part on retrieving the encryption key.

5. The method of claim 1, further comprising:
receiving, from a device associated with the operations cluster, the user input, wherein encrypting the user input is further based at least in part on receiving the user input; and
providing the encrypted user input to the device.

6. The method of claim 1, further comprising:
executing a third application on a cluster of the plurality of clusters using the encrypted user input, wherein the encrypted user input comprises a key-value pair associated with the third application.

7. The method of claim 1, further comprising:
detecting, by the first application, a generation of one or more authentication credentials for a namespace, wherein the generation is detected on at least one cluster of the plurality of clusters;
generating, by the first application, one or more access credentials based at least in part on the one or more authentication credentials; and
transmitting the one or more access credentials to the operations cluster based at least in part on generating the one or more access credentials.

8. The method of claim 1, further comprising:
detecting, by a third application executed on a plurality of second clusters associated with a second environment, a generation of a second encryption key on a primary second cluster of the plurality of second clusters;
transmitting the second encryption key to each second cluster of the plurality of second clusters in response to detecting the generation of the second encryption key on the primary second cluster; and
encrypting, by the second application executed on the operations cluster, a second user input based at least in part on the second encryption key and the second environment.

9. A non-transitory computer-readable medium storing code, the code comprising instructions executable by one or more processors to:
detect, by a first application executed on a plurality of clusters associated with a first environment, a generation of an encryption key on a primary cluster of the plurality of clusters;
transmit the encryption key to each cluster of the plurality of clusters in response to detecting the generation of the encryption key on the primary cluster; and
encrypting, by a second application execute on an operations cluster of the plurality of clusters, a user input based at least in part on the encryption key and the first environment.

10. The non-transitory computer-readable medium of claim 9, wherein the instructions are further executable by the one or more processors to:
identifying, based at least in part on a second user input, the first environment from a plurality of environments, wherein encrypting the user input is based at least in part on identifying the first environment.

11. The non-transitory computer-readable medium of claim 10, wherein the instructions are further executable by the one or more processors to:
receive, from a device associated with the operations cluster, the second user input based at least in part on transmitting an indication of the plurality of environments to the device.

12. The non-transitory computer-readable medium of claim 10, wherein the instructions are further executable by the one or more processors to:
determine that the encryption key is associated with the first environment based at least in part on identifying the first environment; and
retrieve the encryption key based at least in part on the encryption key being associated with the first environment, wherein encrypting the user input is further based at least in part on retrieving the encryption key.

13. The non-transitory computer-readable medium of claim 9, wherein the instructions are further executable by the one or more processors to:
receive, from a device associated with the operations cluster, the user input, wherein encrypting the user input is further based at least in part on receiving the user input; and
provide the encrypted user input to the device.

14. The non-transitory computer-readable medium of claim 9, wherein the instructions are further executable by the one or more processors to:
execute a third application on a cluster of the plurality of clusters using the encrypted user input, wherein the encrypted user input comprises a key-value pair associated with the third application.

15. The non-transitory computer-readable medium of claim 9, wherein the instructions are further executable by the one or more processors to:
detect, by the first application, a generation of one or more authentication credentials for a namespace, wherein the generation is detected on at least one cluster of the plurality of clusters;
generate, by the first application, one or more access credentials based at least in part on the one or more authentication credentials; and
transmit the one or more access credentials to the operations cluster based at least in part on generating the one or more access credentials.

16. The non-transitory computer-readable medium of claim 9, wherein the instructions are further executable by the one or more processors to:
detect, by a third application executed on a plurality of second clusters associated with a second environment, a generation of a second encryption key on a primary second cluster of the plurality of second clusters;
transmit the second encryption key to each second cluster of the plurality of second clusters in response to detecting the generation of the second encryption key on the primary second cluster; and
encrypting, by the second application execute on the operations cluster, a second user input based at least in part on the second encryption key and the second environment.

17. An apparatus, comprising:
one or more memories; and
one or more processors coupled with the one or more memories and configured to cause the apparatus to:
detect, by a first application executed on a plurality of clusters associated with a first environment, a generation of an encryption key on a primary cluster of the plurality of clusters;
transmit the encryption key to each cluster of the plurality of clusters in response to detecting the generation of the encryption key on the primary cluster; and
encrypting, by a second application execute on an operations cluster of the plurality of clusters, a user input based at least in part on the encryption key and the first environment.

18. The apparatus of claim 17, wherein the one or more processors are configured to cause the apparatus to:
identifying, based at least in part on a second user input, the first environment from a plurality of environments, wherein encrypting the user input is based at least in part on identifying the first environment.

19. The apparatus of claim 18, wherein the one or more processors are configured to cause the apparatus to:
receive, from a device associated with the operations cluster, the second user input based at least in part on transmitting an indication of the plurality of environments to the device.

20. The apparatus of claim 18, wherein the one or more processors are configured to cause the apparatus to:
determine that the encryption key is associated with the first environment based at least in part on identifying the first environment; and
retrieve the encryption key based at least in part on the encryption key being associated with the first environment, wherein encrypting the user input is further based at least in part on retrieving the encryption key.
